(19) United States
(12) Patent Application Publication
(10) Pub. No.: US 2002/0136391 A1
(43) Pub. Date: Sep. 26, 2002

(54) System and method for number pooling administration, forecasting, tracking and reporting

(76) Inventor: Bruce Armstrong, Longmont, CO (US)

Correspondence Address: MORRISON & FOERSTER LLP, 2000 PENNSYLVANIA AVE, NW, SUITE 5500, WASHINGTON, DC, 20006-1888, US

(21) Appl. No.: 09/758,229

(22) Filed: Jan. 12, 2001

(51) Int. Cl. H04M 3/00; H04M 15/00

(52) U.S. Cl. 379/242; 379/111

(57) ABSTRACT

This invention provides a system and method to predict and manage a demand for Central Office (CO) codes in a telephone number pooling environment. The invention also provides summary data reflecting CO code forecasted and actual demand, which may be used for public reporting purposes and historical tracking of demand for thousand blocks and CO codes.

### FIELD OF THE INVENTION

This invention relates generally to data processing systems and, more specifically, to systems and methods to forecast a demand of telephone service providers for blocks of telephone numbers.

### BACKGROUND OF THE INVENTION

In the mid-1990s in North America, service providers' demand for telephone number resources increased significantly. A numbering plan area (NPA) refers to the first three digits of a ten-digit telephone number. A NPA is commonly referred to as an area code. A CO code refers to the first three digits of a telephone number and is thus a subset of an area code. CO codes are generally assigned to service providers as a block of ten-thousand telephone numbers. Once a service provider has been assigned a ten-thousand block of numbers, the numbers are included in that service provider's number inventory and cannot be used by another service provider absent explicit permission from a regulatory authority, such as the Federal Communications Commission (FCC) and an underlying technology that supports sharing telephone numbers among service providers.

Each area code can include up to 792 central office (CO) codes. Since a certain number of CO codes in each area code are reserved for specific uses, e.g., 911 and 411, a given area code generally has fewer than 792 CO codes that can actually be assigned to service providers. Each CO code includes ten-thousand telephone numbers. At any given time, the percentage of assigned CO codes may be anywhere from zero to a maximum number of available, i.e., not reserved, CO codes in a specific area code.

Prior to 1995, the second digit of an area code was required to be zero or one. A technological advance in 1995 made it possible for any digit (“0” through “9”) to be used as the second digit of an area code. This expanded the number of area codes from 150 to nearly 750. Because CO codes are a subset of an area code, this increase in the number of area codes led to a relative increase in the number of useable CO codes and telephone numbers, which in turn led to a possibility of increased competition in the telecommunications industry. That is, since more CO codes could be assigned, more companies could receive blocks of ten-thousand numbers and compete in the local telephone markets. However, due to federal government regulation of the local telephone markets at that time few companies were able to serve as service providers in the local telephone market.

In 1996, Congress passed The Telecommunications Act of 1996, which opened local telephone markets to competition. Additional technological advances in data communications technology made it possible for various types of telecommunications companies, including, for example, cellular, personal communications systems (PCS), and paging to enter the local telephone market. Thus, many service providers began to compete in the local telephone market. Each new service provider to enter the local telephone market received a block of CO codes, which, as described above, includes a block of ten-thousand telephone numbers. With the increased number of service providers competing in any given market, each service provider is likely to need fewer of the ten-thousand numbers included in a CO code than a service provider would need when there were fewer service providers competing in a given market. This is because the customer base in a given market did not increase proportionately to the increase in the number of service providers competing in the market. Additionally, smaller service providers have fewer customers to serve and thus do not need as many of the ten-thousand numbers included in a CO code as a larger provider needs. As described above, once a block of numbers has been included in a service provider's number inventory, that block of numbers cannot be used by another service provider absent explicit assignment to the other service provider and an underlying technological support. Thus, blocks of numbers that have been assigned to a service provider and are not being used by the provider, are wasted.

The increased demand for area codes since 1995 has prompted state and federal regulators to implement a number of techniques directed to optimizing allocation of number resources, including assignment of area codes and CO codes. Pooling of numbers among service providers is one of the methods that has been adopted by the Federal Communications Commission to retard the exhaustion of area codes by more efficiently allocating numbering resources, which include CO codes and telephone numbers, to service providers. While the FCC has delegated authority to implement number pooling in some states, number pooling remains optional in other states.

Number pooling allows telecommunications service providers who use telephone numbers to cooperatively extend the exhaust date of an NPA by donating their unused numbers to a pool of numbers that can be assigned to other service providers. Until recently, a service provider could not access numbers that had previously been assigned to another service provider. Pooling, however, allows a service provider to donate its unused numbers to a central pool, which is administered by a pooling administrator, for reassignment to another service provider. Because pooling frees unused numbers that would otherwise sit idle in one service provider's telephone number inventory for allocation to customers who receive their telephone number from another service provider, pooling decreases waste of telephone numbers, which in turn decreases the time in which an area code will be exhausted, i.e., when an area code will run out of numbers that can be assigned.

Number pooling decreases waste of unused numbers included in a service provider's number inventory by allowing such unused numbers to be “pooled,” or shared, among service providers within specific geographic areas, referred to as rate centers. By sharing unused numbers among service providers, the exhaust of an area code may be significantly retarded because fewer numbers are wasted. That is, in number pooling, unused numbers are “ported” from one service provider to another such that a second service provider may assign to customers numbers that were previously allocated to a first service provider. Number pooling relies on a technology referred to as local number portability (LNP), which allows the numbers that were previously assigned to one service provider to be assigned to another service provider. LNP allows a telephone customer to retain the same telephone number when changing from one service provider to another service provider, assuming that customer is still located in the same rate center. With LNP, incoming calls to customers who have changed service providers but have maintained the same telephone number are directed to the appropriate, i.e., the current, service provider according to the results of an LNP database query.

In a number pooling regime, a pooling administrator (PA), who is selected by a regulatory commission that authorizes (or mandates) pooling in a rate center, coordinates the demand for number resources for all service providers participating in a pool. The PA is also responsible for establishing a pool. That is, the PA assigns blocks of numbers to service providers. Rather than assigning an entire CO code, i.e., a ten-thousand block of numbers, to a service provider, the PA may assign blocks of numbers to service providers in one-thousand block increments, referred to herein as a thousand block of numbers. The one-thousand block of numbers may have previously been included in another service provider's number inventory. Entities that are not pooling-capable, i.e., entities that do not have local number portability, or are not participating in a pool receive their numbering resources directly from the North American Numbering Plan Administrator (NANPA). The NANPA also provides CO codes to the PA to replenish the PA's inventory of blocks of numbers and to satisfy CO code requests from service providers who participate in pooling.

A major responsibility of the designated PA is to manage thousand blocks of telephone numbers that are used to satisfy various service providers' demand. To forecast each service provider's demand, the PA uses a combination of thousand block forecasts provided by the service providers who provide telephone numbers in a particular rate center, historical thousand block demand, and other forecasting techniques. Historically, service providers' demand for thousand blocks has been significantly lower than the forecasts provided to the PA. If the PA obtains CO codes from the NANPA based on inflated forecasts of service providers' demand, number pooling will fail to yield its expected benefits. In addition to managing allocation of CO codes to service providers, the PA provides to various organizations in the telecommunications industry, industry regulators, and the public information indicating both the allocation and use of CO codes. The information may include, for example, aggregated forecasts, assignments of one-thousand blocks of numbers, and available CO codes.

Replenishing the PA's inventory of available thousand blocks is accomplished when the PA requests additional CO codes from the NANPA. This process generally takes a minimum of 66 days. Therefore, the PA is not able to instantly satisfy demands of service providers if it does not have sufficient inventory of its own. The difference between the total thousand block demand forecasted by the PA and the number of donated thousand blocks in each rate center provides the PA with a measure of thousand blocks needed to satisfy the pool. If donations exceed demand, no CO code resources are necessary to satisfy the pool. Alternatively, if demand exceeds donations, the PA obtains additional CO code resources from the NANPA. Therefore, it is important that the PA have an accurate indication of the service providers' demand.

Service providers create demand forecasts regularly. However, such forecasts are generally inaccurate and tend to significantly exceed actual demand. Therefore, using the service providers' forecasts to predict CO code demand generally results in the PA obtaining more CO code resources from the NANPA than are necessary to meet actual demand, thereby exacerbating the problem of inefficient number utilization by causing CO codes to be opened prematurely. The prematurely opened CO codes are not available for use by other service providers and sit idle with the service provider that they have been allocated to.

Accordingly, a need exists for a system and method to accurately forecast a service provider's demand for CO codes so that a number of CO codes that are opened and assigned closely accords with demand.

### SUMMARY OF THE INVENTION

In accordance with an embodiment of this invention, a method to predict when a subset of items, which are included in a set of like items, will be exhausted is provided. The method includes determining a forecasted demand for the subset of items during a specific time period, determining an actual demand for the subset of items during at least a portion of the specific time period, and predicting, according to the forecasted demand and the actual demand, when the set of items will be exhausted.

In accordance with another embodiment of this invention, a method to predict when a block of telephone numbers in an area code will be assigned to service providers is provided. The method includes determining a forecast of the service providers' demand for telephone numbers during a specified time period, determining an actual service providers' demand for telephone numbers during at least a portion of the specified time period, and predicting, according to the forecast of the service providers' demand and the actual service providers' demand, when the block of telephone numbers in the area code will be assigned to service providers.

In accordance with another embodiment of this invention, a method to predict when a block of telephone numbers in an area code will be assigned to service providers operating in the area code is provided. The method includes establishing a pool of telephone numbers that can be shared among the service providers such that the telephone numbers can be allocated to a first service provider and subsequently allocated to a second service provider, forecasting a demand for the telephone numbers, determining an actual demand for the telephone numbers, and predicting, according to the forecasted demand and the actual demand, when the telephone numbers in the area code will be assigned to the service providers.

In accordance with yet another embodiment of this invention, a method to predict when a block of telephone numbers in an area code will be assigned to service providers is provided. The method includes establishing a pool of telephone numbers that can be shared among the service providers such that the telephone numbers included in the pool of telephone numbers can be allocated to a first service provider and subsequently allocated to a second service provider, determining a forecast of the service providers' demand for telephone numbers during a specified time period, and predicting when the block of telephone numbers in the area code will be assigned to service providers.

In accordance with still another embodiment of this invention, a system to predict when a block of telephone numbers in an area code will be assigned to service providers is provided. The system includes a module that determines a forecast of service providers' demand for telephone numbers, and predicts when the block of telephone numbers will be assigned to service providers.

In accordance with another embodiment of this invention, a system to predict when a block of telephone numbers in an area code will be assigned to service providers is provided. The system includes a module that determines a forecast of service providers' demand for telephone numbers during a specified time period, determines an actual service providers' demand for telephone numbers during at least a portion of the specified time period, and predicts, according to the forecast of the service providers' demand and the actual service providers' demand, when the block of telephone numbers in the area code will be assigned to service providers.

### BRIEF DESCRIPTION OF THE DRAWINGS

FIG. 1 depicts an illustrative flow diagram of a process to establish and manage a pool of telephone number resources.

FIG. 2 depicts an illustrative flow diagram of an ongoing pool management process.

FIGS. 3A-3D depict illustrative output reports provided by the invention.

### DETAILED DESCRIPTION OF THE INVENTION

Generally, the invention forecasts a demand for a subset of items that are included in a larger set of the items, and helps manage the demand for the items included in the set of items by determining when the set of items will be exhausted. More particularly, the invention determines both forecasted and actual demands for the subset of items during specific time periods and predicts when the set of items will be exhausted according to the forecasted and actual demands. The forecasted demand can be determined in a variety of ways, including, for example, receiving a forecasted demand from an entity involved in distribution of the items, or computing a forecasted demand based on a demand during a prior time period. Alternatively, the forecasted demand may be computed as an estimation of the demand for the items according to, for example, sales of related items. The actual demand is determined according to an actual demand during a portion of the specific time period for which actual demand data is available. Preferably, the actual demand is received from an entity responsible for distribution of the subset of items. Similarly, the actual demand may be extracted from a repository that reflects an available inventory of the subset of items. The prediction reflecting when the items will be exhausted is computed according to a computation that reflects both the forecasted demand and the actual demand. More particularly this prediction is computed as the sum of the forecasted demand and the actual demand during the specific time period.

The invention may be used to predict the exhaust of various subsets of items. Alternative embodiments of the invention may used to predict, for example, unused parts stored in a warehouse, available living units, e.g., apartments, included in a community, or blocks of available telephone numbers.

The following description describes an embodiment of the invention in which blocks of available telephone numbers are predicted although the methodology used in this embodiment can be directly applied to alternative embodiments in order to predict exhaust of items. In this description, the set of items corresponds to the telephone numbers that are included in a particular rate center, and the subset of items corresponds to telephone numbers that are allocated to a particular service provider.

In particular, this embodiment of the invention provides a pool management tool that forecasts a demand, during a specified period of time, for CO codes and helps manage the demand by determining when additional CO codes need to be opened. The forecast computed by this tool can reflect both aggregate demand forecasts provided by service providers and actual demand. The actual demand reflects a number of CO codes that were assigned to service providers during a specified time period. This pool management tool automatically re-computes its demand forecasts upon receiving updated forecast or actual usage data. Overall, this tool provides assistance to a pooling administrator (PA) with regard to both establishing a pool and ongoing management of the pool.

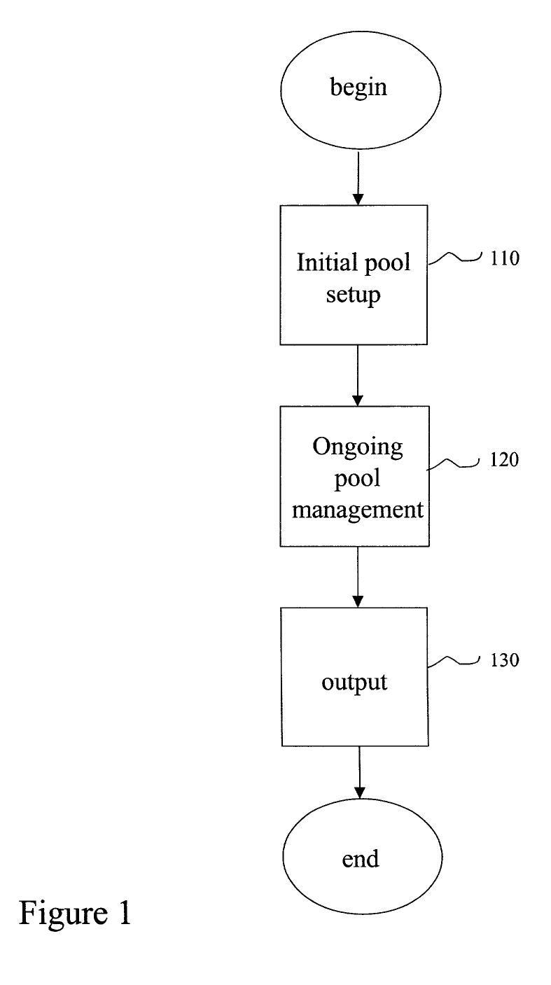

FIG. 1 provides an illustrative flow diagram of a process to establish and manage a pool of telephone number resources. Initially, a pool of telephone numbers is setup from donations of telephone numbers by service providers in a particular rate center (110). As described above, a particular pool is limited to satisfying the telephone number demand for service providers operating in an indicated geographic area, or rate center. Once a pool has been established, this invention manages the telephone number resources included in the pool (120). Ongoing pool management ensures that each service provider's requirements can be satisfied from the pool and includes determining when, for example, an additional CO code needs to be opened to satisfy such demand. This pool management tool also provides output in the form of, for example, reports or charts indicating a status of a pool at a particular time, either actual or forecasted (130). This output reflects a visual representation of the pool status as determined during the ongoing pool management process (120).

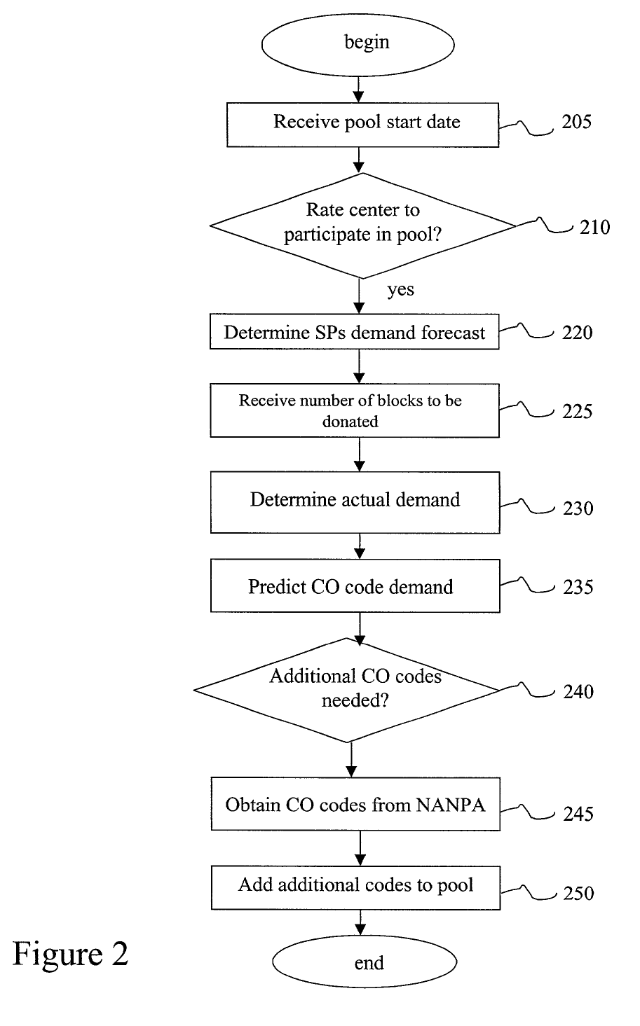

FIG. 2 depicts an illustrative flow diagram of an ongoing pool management process. The regulatory body that authorizes pooling in a specific rate center provides the PA with a pooling start date (205). Then, the PA receives various other information relevant to establishing a pool of telephone numbers that can be shared among the service providers operating in the specific rate center. First, the PA determines whether a particular rate center will participate in a pool (210). This determination is made according to received information indicating which rate centers are LNP-capable and can therefore participate in a pool. Because present limitations of LNP technology only support sharing of numbers within a rate center, each rate center is treated as a separate pool. One of skill in the art will appreciate that this invention can also be used to manage a pool that includes number resources from multiple rate centers. Data reflecting which rate centers are LNP-capable can be obtained from, for example, the Local Exchange Routing Guide (LERG) and the Number Portability Administration Center (NPAC). The LERG data, which is currently maintained by Telcordia, Inc. and is publicly available, provides details of CO code assignments and indicates which service providers and rate centers may implement pooling. The NPAC is a centralized database that includes various LNP-related information and is currently maintained by NeuStar, Inc.

Then, a forecasted demand is determined (220). This determination reflects a demand forecast indicating a demand for thousand blocks of numbers during a specified time period for each service provider operating in a LNP-capable rate center, regardless of whether the provider is participating in pooling. Thousand blocks of numbers refers to a block of one-thousand consecutive telephone numbers that the service provider can assign to customers. These forecasts are generally submitted twice each year, although they may be submitted more frequently. Next, each service provider operating in the rate center provides an indication of a number of thousand blocks that it will donate to a pool (225). Under current Federal regulations (i.e., FCC regulations), each service provider participating in number pooling is required to donate to the pool any thousand blocks of numbers that are not forecast to be assigned to customers in the upcoming six months. Thus, for example, if a provider has an entire CO code, or 10 thousand blocks (i.e., ten blocks of one-thousand numbers, which may not be consecutive, or ten thousand blocks), and needs three of those thousand blocks to satisfy its need for resources, then the other seven-thousand blocks must be donated to the pool. Then, actual CO code demand in a pooling environment is determined as follows (230). Each service provider operating in the rate center provides information indicating an actual CO code demand during a portion of the specified time period for which actual demand data is available. This information reflects a number of CO codes that have been assigned to the server provider since pooling has begun.

Then, the CO code demand can be predicted (235). The pooling manager computes a total demand for CO codes for the rate center, which indicates when the thousand blocks of numbers in the area code will be assigned to service providers. This prediction is provided in the form of, for example, a demand forecast. This demand forecast is computed in the following two ways: (1) using the sum of the demand forecasts of the service providers; and (2) combining actual demand up to the current date using service provider demand forecasts as representative of future demand. Since service providers cannot receive more thousand blocks than indicated in their current forecast, this provides an upper bound to the amount of resources necessary to meet the demand. These computations are generally performed to determine a number of CO codes that will be need to be opened within a year. As described above, since opening a new CO code is an administrative process that generally requires at least 66 days, it is important that this forecast be performed at least several months prior to when additional CO codes are needed.

More specifically, an aggregate service provider demand is computed according to a demand forecast provided by each of the service providers operating in a rate center. The difference between the number of donated thousand blocks and the demand represents a deficiency. An appropriate number of CO codes will therefore be opened to satisfy the deficiency. The difference in the maximum number of thousand blocks in a CO code, i.e., 10 thousand blocks, and the number of CO codes that will be used to satisfy the deficiency, reflects a number of spare thousand blocks. This set of calculations is performed on a month by month basis, with the spare thousand blocks of one month being assigned, as needed, to satisfy demand in subsequent months. Then, while substituting the actual demand for the forecasted demand, for each month that actual demand data is available, the above series of calculations is repeated.

If the computations indicate that additional CO codes are needed to satisfy demand (240), then the PA requests such additional CO codes from the NANPA (245). And the additional CO codes are added to the pool (250).

Each time an event occurs that changes the status of the pool, including, for example, the assignment of thousand blocks to service providers, changes in service provider forecasts, and the number of CO codes received from the NANPA, the PA enters the appropriate data into the system. The system automatically adjusts all parameters and presents a revised forecast to the PA. Thus, when the system receives updated demand forecasts from service providers, or additional donations of thousand blocks, it repeats the above calculations so that the CO code demand forecasts will be updated accordingly. For example, additional thousand blocks may be donated when a service provider decides to increase a number of donated blocks to reflect the provider's six or nine month inventory, rather than the provider's six month inventory, as currently suggested by the FCC.

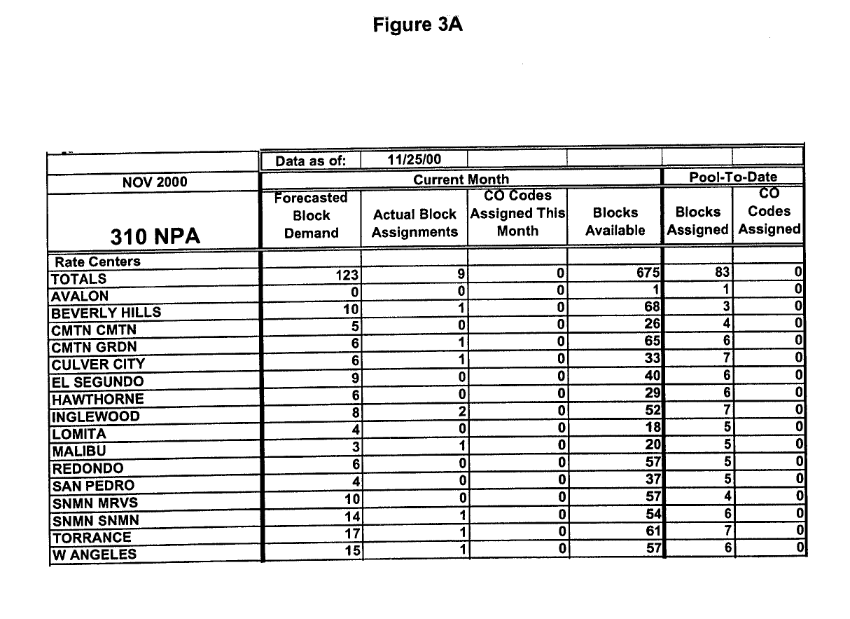

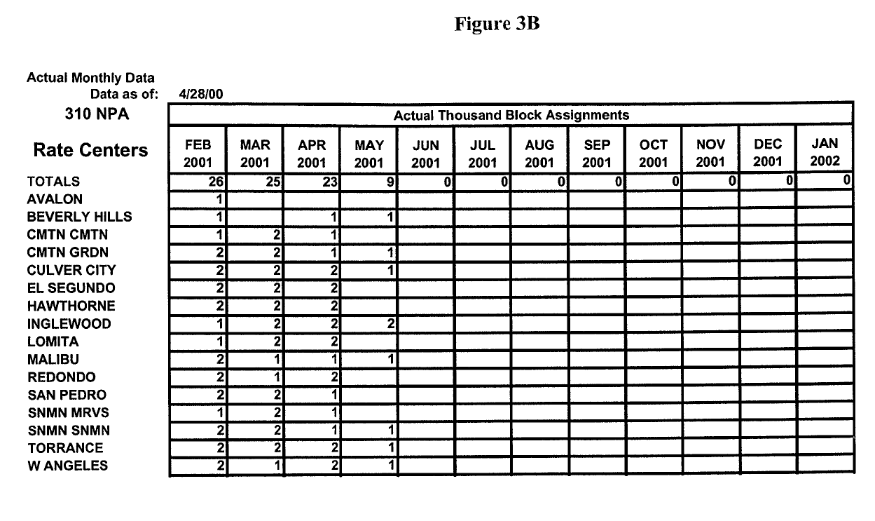

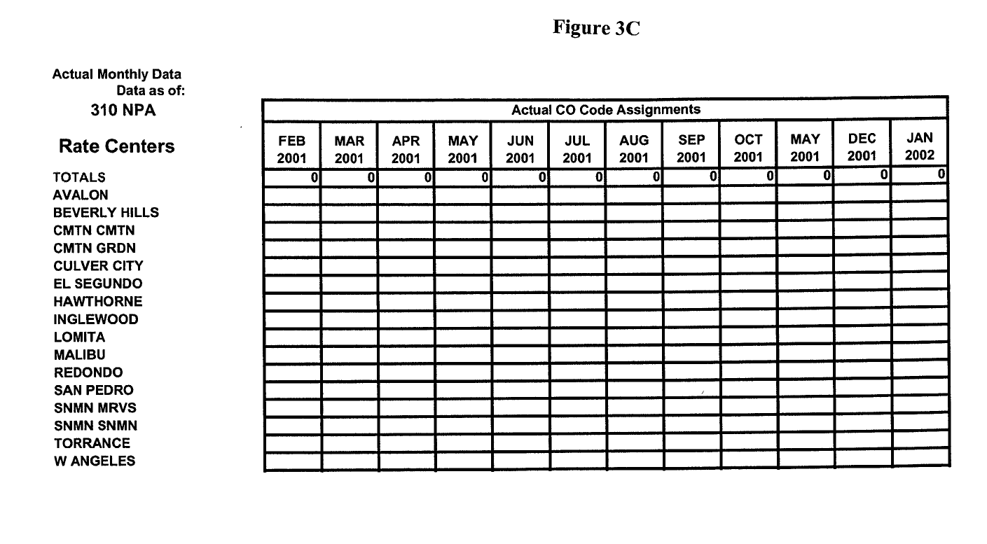

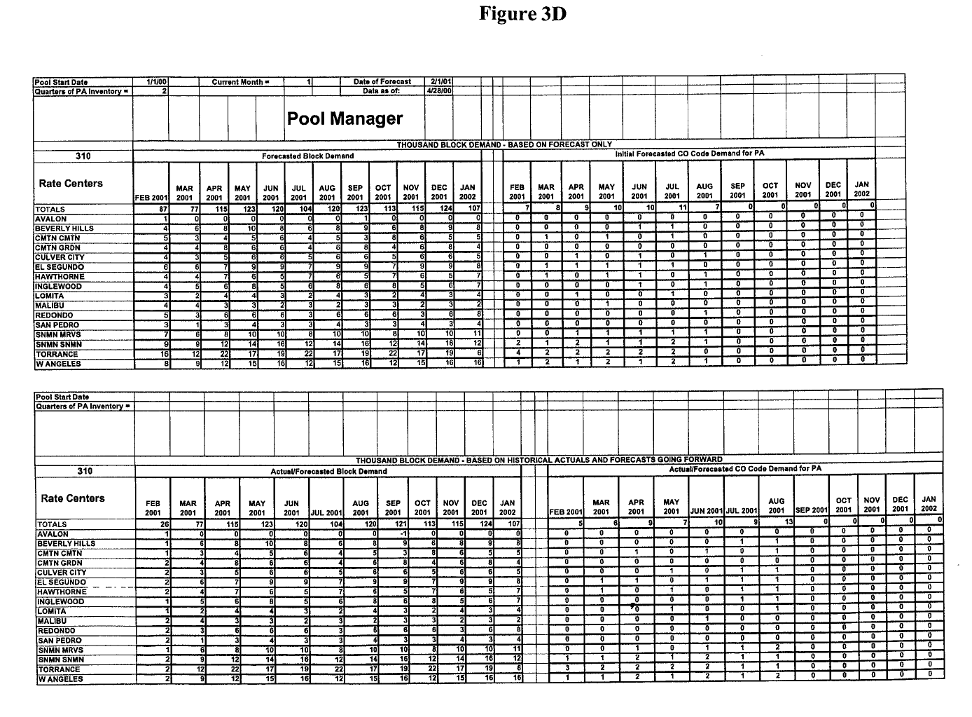

The system produces various reports that display the computed demand forecasts. FIGS. 3A-3D depict illustrative reports. FIG. 3A depicts a current pool status report. This report reflects a current month's forecasted demand for thousand blocks, the current month's actual thousand block assignments, the current month's actual CO code assignments, a total number of thousand blocks that have been assigned, and the total number of CO codes that have been opened. Each of these values is provided for each rate center that is participating in pooling. FIGS. 3B and 3C depict thousand block assignments and CO code openings by month and by rate center. The data reflected in this report is provided by a PA. FIG. 3D depicts an illustrative report of a complete forecast of CO code requirements by rate center and by month. This forecast report is divided into the three sections: (1) a forecast based solely on total service provider forecasts; (2) a forecast that substitutes forecast data with actual historical thousand block assignment data and recalculates the demand for CO codes; (3) a summary of the total activity in the pool prior to the current forecast date (i.e., total donations, total CO codes opened and total number of thousand blocks assigned).

### EXAMPLE

The following example steps through the processing relative to predicting a CO code demand for an exemplary rate center. Suppose that this analysis is being performed in November for a pool that was setup in August. The aggregate service provider forecasts from August through July are as follows:

TABLE 1

| | Thousand Block |
|---|---|
| Month | Forecast |
| August | 8 |
| September | 9 |
| October | 12 |
| November | 15 |
| December | 16 |
| January | 12 |
| February | 15 |
| March | 16 |
| April | 12 |
| May | 15 |
| June | 16 |
| July | 16 |

Suppose further that at the beginning of this reporting period, 63 thousand blocks of CO codes are available to be assigned to service providers. Since this analysis is being performed in November for a pool that was created in August, four months of actual demand data are available. The following table shows the actual demand from August through November:

TABLE 2

| | Actual Thousand |
|---|---|
| Month | Blocks Assigned |
| August | 2 |
| September | 1 |
| October | 2 |
| November | 1 |

Now, the computations described above can be performed. The CO code demand forecast is first computed with the aggregate demand forecasts of each of the service providers operating in the relevant rate center (see Table 1). As described above, this includes determining the sum of the aggregate demand forecast for the next six months, and is calculated as follows: sum (8, 9, 12, 15, 16,12)=72. Since the total number of available thousand blocks through donations is 63, there is a deficiency of 9 thousand blocks (72−63=9) to retain a six month inventory. Therefore, after the first month, an additional CO code, which includes 10 thousand blocks, will be opened.

Moving forward to the next month, one CO code has been opened and one spare thousand block is available. The forecasted demand for the next sixth months, i.e., through February, in the exemplary rate center includes an additional 15 thousand blocks. Therefore, a deficiency of 14 thousand blocks would occur. In order to meet the deficiency in that second month, two CO codes, (for a total of twenty-thousand blocks) needs to be opened. The two codes satisfies the deficiency and yields six spare thousand blocks.

Moving forward to the forecasted demand for March, an additional 16 thousand blocks are needed. Since there are only 6 spare thousand blocks that have been carried over from the previous month, there exists a deficiency of 10 thousand blocks. Opening one additional CO code satisfies this deficiency, leaving no spare thousand blocks.

This process is continued for each month that is reflected in a service provider's demand forecast.

Next, the above series of calculations is re-computed for each of the months for which actual demand data is available. In this series of computations, the forecasted demand for thousand blocks is replaced with the actual demand. Continuing with the example and using the actual demand data for August through November, in August, the available thousand blocks from donations is 63 blocks. The sum of the demand for thousand blocks for the first six months is 34=sum (2, 1, 2, 1, 16, and 12) (See Tables 1 and 2). Since 29 spare thousand blocks (63-34) remain available after filling the request for 34 blocks, no CO codes are opened in the first month. In the second month (September), the demand forecast is for fifteen-thousand blocks (from February). Since 29 thousand blocks remain available, no additional CO codes need to be opened. And 14 spare thousand blocks remain. In the third month (October), another 16 thousand blocks is forecast (from March). Therefore, a deficiency of two blocks exists. In order to satisfy this deficiency, one additional CO code needs to be opened. Opening one CO code leaves two spare thousand blocks. This process is continued for each month for which there is data, using the forecast data for the months for which actual demand data is not available.

While this invention has been described relative to a particular embodiment, one of sill in the art will appreciate that this description is illustrative and therefore does not limit the scope of the invention. This invention is limited only be the appended claims and the full scope of their equivalents.

What is claimed is:

1. A method to predict when a subset of items, which are included in a set of like items, will be exhausted, comprising:
determining a forecasted demand for the subset of items during a specific time period;
determining an actual demand for the subset of items during at least a portion of the specific time period; and
predicting, according to the forecasted demand and the actual demand, when the set of items will be exhausted.

2. The method of claim 1, wherein determining the forecasted demand includes computing the forecasted demand according to a demand during a prior time period.

3. The method of claim 1, wherein determining the actual demand includes receiving the actual demand from a third party.

4. The method of claim 1, wherein the predicting includes computing a demand according to a sum of the forecasted demand and the actual demand during the specific time period.

5. A method to predict when a block of telephone numbers in an area code will be assigned to service providers, comprising:
determining a forecast of the service providers' demand for telephone numbers during a specified time period;
determining an actual service providers' demand for telephone numbers during at least a portion of the specified time period; and
predicting, according to the forecast of the service providers' demand and the actual service providers' demand, when the block of telephone numbers in the area code will be assigned to service providers.

6. The method of claim 5, further comprising establishing a pool of telephone numbers that can be shared among the service providers such that the pool of telephone numbers can be allocated to a first service provider and subsequently allocated to a second service provider.

7. The method of claim 5, further comprising providing a report reflecting a status of the telephone numbers that are included in the area code.

8. The method of claim 5, further comprising allocating to the service provider a block of telephone numbers that was previously allocated to an other service provider.

9. The method of claim 5, further comprising receiving information indicating a start date of the pool.

10. The method of claim 5, further comprising requesting an additional block of telephone numbers according to the predicting.

11. A method to predict when a block of telephone numbers in an area code will be assigned to service providers operating in the area code, the method comprising:
establishing a pool of telephone numbers that can be shared among the service providers such that the telephone numbers can be allocated to a first service provider and subsequently allocated to a second service provider;
forecasting a demand for the telephone numbers;
determining an actual demand for the telephone numbers; and
predicting, according to the forecasted demand and the actual demand, when the telephone numbers in the area code will be assigned to service providers.

12. A method to predict when a block of telephone numbers in an area code will be assigned to service providers, comprising:
establishing a pool of telephone numbers that can be shared among the service providers such that the pool of telephone numbers can be allocated to a first service provider and subsequently allocated to a second service provider;
determining a forecast of the service providers' demand for telephone numbers during a specified time period; and
predicting when the block of telephone numbers in the area code will be assigned to service providers.

13. A system to predict when a block of telephone numbers in an area code will be assigned to service providers, comprising a module that determines a forecast of service providers' demand for telephone numbers, and predicts when the block of telephone numbers in the area code will be assigned to service providers.

14. A system to predict when a block of telephone numbers in an area code will be assigned to service providers, comprising a module that determines a forecast of service providers' demand for telephone numbers during a specified time period, determines an actual service providers' demand for telephone numbers during a portion of the specified time period, and predicts, according to the forecast of the service providers' demand and the actual service providers' demand, when the block of telephone numbers in the area code will be assigned to service providers.
